(19) United States
(12) Patent Application Publication
(10) Pub. No.: US 2025/0194454 A1
(43) Pub. Date: Jun. 19, 2025

(54) SYSTEM AND METHOD FOR MONITORING SOIL PROPERTIES WITHIN A FIELD DURING AN AGRICULTURAL OPERATION

(71) Applicant: CNH Industrial America LLC, New Holland, PA (US)

(72) Inventors: Michael Christopher Conboy, Chicago, IL (US); Brittany Schroeder, Bunker Hill, IN (US); Bill Yen, Winnetka, IL (US)

(21) Appl. No.: 18/545,006

(22) Filed: Dec. 19, 2023

(51) Int. Cl. A01B 79/00

(52) U.S. Cl. CPC A01B 79/005

(57) ABSTRACT

An agricultural system for monitoring soil properties within a field includes an agricultural implement having a frame, ground engaging tools supported on the frame, and a position sensor configured to generate position data indicative of a distance between the frame and a surface of the field. The agricultural system further includes soil property sensors supported on the agricultural implement and spaced apart along a vertical direction, where each of the soil property sensors generates data indicative of at least one soil property when positioned below the surface of the field. Additionally, the agricultural system includes a computing system configured to receive the position data, determine when one or more of the soil property sensors are positioned above the surface of the field based at least in part on the position data, and deactivate the one or more soil property sensors positioned above the surface of the field.

### FIELD OF THE INVENTION

The present disclosure relates generally to monitoring soil properties within a field and, more particularly, to systems and methods for monitoring soil properties at different depths within a field while performing an agricultural operation with an associated agricultural implement.

### BACKGROUND OF THE INVENTION

A wide range of agricultural implements have been developed and are presently in use for tilling, cultivating, harvesting, and so forth. Tillage implements, for example, are commonly towed behind tractors and may cover wide swaths of ground that include various types of residue. Accordingly, tillers typically include ground-engaging tools, such as coulters, shanks, tillage points, and/or the like, configured to condition the soil for improved soil composition, such as organic matter, residue, and/or moisture content or distribution while reducing soil compaction from sources such as machine traffic, grazing cattle, and standing water. The ground-engaging tools may be selected depending upon the soil properties and the desired results of the tilling operation. Conventional tillage practices include setting a predetermined penetration depth for the ground-engaging tools of the implement and pulling the implement across a field to till the soil.

Soil properties, including the soil composition and the soil temperature, below the surface of the field may affect subsequent operations within the field, such as fertilizing, seeding, planting, etc. For example, the desired penetration depth and/or force applied to furrow-closing tools of a seed-planting implement may be based on the soil properties of the field. Typically, soil sensors provided in association with tillage implements are only configured to generate data indicative of the soil properties at one depth within the field. However, the soil properties at different depths within the field may vary significantly, which may affect the quality of subsequent field operations.

Accordingly, an improved system and method for monitoring soil properties at different depths within a field during an agricultural operation would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to an agricultural system for monitoring soil properties within a field. The agricultural system may include an agricultural implement having a frame, a plurality of ground engaging tools supported on the frame, with each of the plurality of ground engaging tools being configured to engage soil within a field to perform an agricultural operation as the agricultural implement moves across the field, and a position sensor configured to generate position data indicative of a distance between the frame and a surface of the field. The agricultural system may further include a plurality of soil property sensors supported on the agricultural implement and spaced apart along a vertical direction, where each of the plurality of soil property sensors may be configured to generate soil property data indicative of at least one soil property when positioned below the surface of the field. Additionally, the agricultural system may include a computing system configured to receive the position data generated by the position sensor, determine when one or more sensors of the plurality of soil property sensors are positioned above the surface of the field based at least in part on the position data, and deactivate the one or more sensors of the plurality of soil property sensors determined to be positioned above the surface of the field.

In another aspect, the present subject matter is directed to an agricultural method for monitoring soil properties within a field during an agricultural operation with an agricultural implement, where the agricultural implement may have a frame configured to support a plurality of ground engaging tools, with each of the plurality of ground engaging tools being configured to engage soil within the field to perform the agricultural operation. The agricultural method may include receiving, with a computing system, position data generated by a position sensor of the agricultural implement, the position data being indicative of a distance between the frame and a surface of the field. The agricultural method may further include determining, with the computing system, when one or more sensors of a plurality of soil property sensors supported on the agricultural implement are positioned above the surface of the field based at least in part on the position data, with the plurality of soil property sensors being spaced apart along a vertical direction, and with each of the plurality of soil property sensors being configured to generate soil property data indicative of at least one soil property when positioned below the surface of the field. Additionally, the agricultural method may include deactivating, with the computing system, the one or more sensors of the plurality of soil property sensors determined to be positioned above the surface of the field.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of an agricultural implement coupled to a work vehicle in accordance with aspects of the present subject matter;

FIG. 2 illustrates another perspective view of the agricultural implement shown in FIG. 1 in accordance with aspects of the present subject matter;

FIG. 3 illustrates a soil property sensing system for monitoring soil properties during an agricultural operation with the agricultural implement of FIGS. 1 and 2 in accordance with aspects of the present subject matter;

FIG. 4 illustrates an exploded view of part of the soil property sensing system shown in FIG. 3 in accordance with aspects of the present subject matter, particularly illustrating first soil property sensors;

FIG. 5 illustrates an exploded view of another part of the soil property sensing system shown in FIG. 3 in accordance with aspects of the present subject matter, particularly illustrating second soil property sensors;

FIG. 6 illustrates a schematic view of a system for monitoring soil properties at different depths within a field during an agricultural operation in accordance with aspects of the present subject matter; and

FIG. 7 illustrates a flow diagram of one embodiment of a method for monitoring soil properties at different depths within a field during an agricultural operation in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield still a further embodiment. Thus, it is intended that the present invention covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein will be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present subject matter is directed to systems and methods for monitoring soil properties at different depths within a field during an agricultural operation. More particularly, in accordance with aspects of the present subject matter, an agricultural implement may include a soil property sensing system having a plurality of soil property sensors configured to detect one or more soil properties, such as soil moisture, soil temperature, and/or the like. The soil property sensors may be spaced apart along a vertical direction such that the monitored soil property(ies) may be monitored at a plurality of depths during an agricultural operation with the agricultural implement. The depth of the soil property sensors may be monitored based at least in part on position data generated by a position sensor and indicative of a position of a frame of the agricultural implement above a surface of the field. When a soil property sensor is detected to be above the surface of the field, the soil property sensor is deactivated or turned off. Generally, the data generated by the sensors above the surface of the field would not be useful and energizing a sensor causes wear on the sensor. As such, strain on computing resources is lessened, as the soil property sensors do not generate data to be analyzed when the data would not be useful, and the useful life of the soil property sensors may be increased, as they are deactivated or turned off whenever they will not produce useful data, which reduces costs. In some instances, the soil property sensors include different types of soil property sensors configured to detect different soil properties. For example, in one instance, the plurality of soil property sensors include first soil property sensors (e.g., infrared sensors) spaced apart from each other and configured to detect a first soil property (e.g., temperature), and second soil property sensors (e.g., capacitance sensors) spaced apart from each other and configured to detect another soil property (e.g., soil moisture). In one instance, the first soil property sensors are housed separately from the second soil property sensors such that the sensor array may be modular, such that only the set of soil property sensors that has worn out sensors has to be replaced at a given time, which further reduces costs.

The soil property data generated by the soil property sensor(s) may be monitored to determine the soil property(ies) of the field at the different depths. In some instances, a control action is performed based on the determined soil property(ies) at the different depths. For instance, in one embodiment, the control action may include controlling an operation of the agricultural implement to adjust a penetration depth of ground-engaging tools of the agricultural implement and/or to adjust a ground speed of the agricultural implement based on the soil property(ies) at the different depths. In some instances, the control action may include controlling an operation of a user interface associated with the agricultural implement to indicate the soil property(ies) at the different depths and/or to recommend a penetration depth, a ground speed, and/or the like based on the soil property(ies) at the different depths. The control action may also include automatically controlling another soil property sensing system on the implement to begin collecting data and/or to automatically control an operation of the implement based on the soil property(ies) at the different depths.

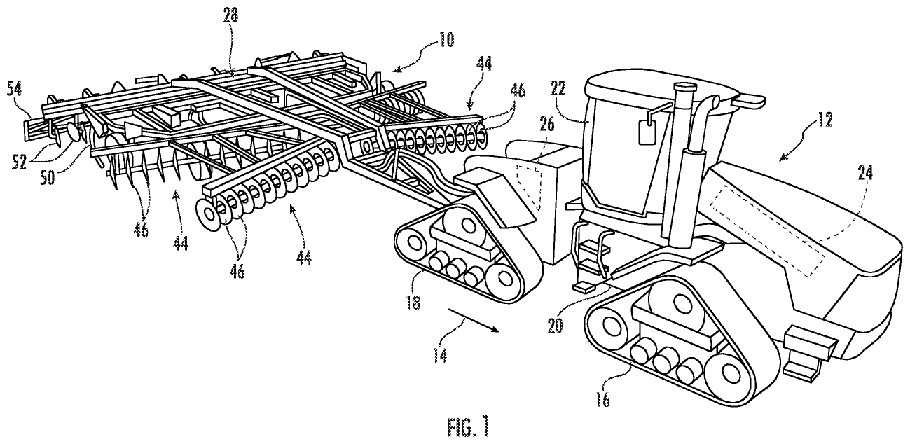

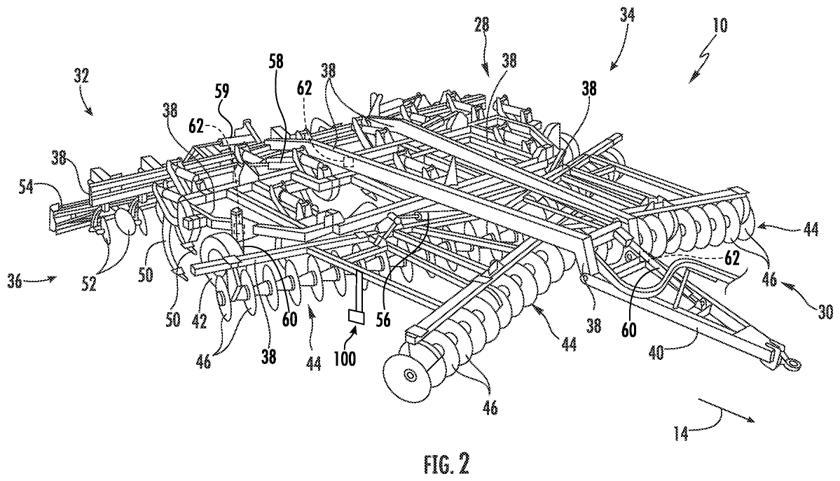

Referring now to the drawings, FIGS. 1 and 2 illustrate differing perspective views of one embodiment of an agricultural implement 10 in accordance with aspects of the present subject matter. Specifically, FIG. 1 illustrates a perspective view of the agricultural implement 10 coupled to a work vehicle 12. Additionally, FIG. 2 illustrates a perspective view of the implement 10, particularly illustrating various components of the implement 10.

In general, the implement 10 may be configured to be towed across a field in a direction of travel (e.g., as indicated by arrow 14 in FIG. 1) by the work vehicle 12. As shown, the implement 10 may be configured as a tillage implement, and the work vehicle 12 may be configured as an agricultural tractor. However, in other embodiments, the implement 10 may be configured as any other suitable type of implement, such as a seed-planting implement, a fertilizer-dispensing implement, and/or the like. Similarly, the work vehicle 12 may be configured as any other suitable type of vehicle, such as an agricultural harvester, a self-propelled sprayer, and/or the like.

As shown in FIG. 1, the work vehicle 12 may include a pair of front track assemblies 16, a pair or rear track assemblies 18, and a frame or chassis 20 coupled to and supported by the track assemblies 16, 18. An operator's cab 22 may be supported by a portion of the chassis 20 and may house various input devices for permitting an operator to control the operation of one or more components of the work vehicle 12 and/or one or more components of the implement 10. Additionally, as is generally understood, the work vehicle 12 may include an engine 24 and a transmission 26 mounted on the chassis 20. The transmission 26 may be operably coupled to the engine 24 and may provide variably adjusted gear ratios for transferring engine power to the track assemblies 16, 18 via a drive axle assembly (not shown) (or via axles if multiple drive axles are employed).

As shown in FIGS. 1 and 2, the implement 10 may include a frame 28. More specifically, as shown in FIG. 2, the frame 28 may extend longitudinally between a forward end 30 and an aft end 32. The frame 28 may also extend laterally between a first side 34 and a second side 36. In this respect, the frame 28 generally includes a plurality of structural frame members 38, such as beams, bars, and/or the like, configured to support or couple to a plurality of components. Furthermore, a hitch assembly 40 may be connected to the frame 28 and configured to couple the implement 10 to the work vehicle 12. Additionally, a plurality of wheels 42 (one is shown) may be coupled to the frame 28 to facilitate towing the implement 10 in the direction of travel 14.

In several embodiments, the frame 28 may be configured to support various ground-engaging tools. For instance, the frame 28 may support one or more gangs or sets 44 of disk blades 46. Each disk blade 46 may be configured to penetrate into or otherwise engage the soil as the implement 10 is being pulled through the field. In this regard, the various disk gangs 44 may be oriented at an angle relative to the direction of travel 14 to promote more effective tilling of the soil. In the embodiment shown in FIGS. 1 and 2, the implement 10 includes four disk gangs 44 supported on the frame 28 adjacent to its forward end 30. However, it should be appreciated that, in alternative embodiments, the implement 10 may include any other suitable number of disk gangs 44, such as more or fewer than four disk gangs 44. Furthermore, in one embodiment, the disk gangs 44 may be mounted to the frame 28 at any other suitable location, such as adjacent to its aft end 32.

Moreover, as shown, in one embodiment, the implement frame 28 may be configured to support other ground-engaging tools. For instance, in the illustrated embodiment, the frame 28 is configured to support a plurality of shanks 50 configured to rip or otherwise till the soil as the implement 10 is towed across the field. Furthermore, in the illustrated embodiment, the frame 28 is also configured to support one or more finishing tools, such as a plurality of leveling blades 52 and/or rolling (or crumbler) basket assemblies 54 rotatable relative to the frame 28. However, in other embodiments, any other suitable ground-engaging tools may be coupled to and supported by the implement frame 28, such as a plurality closing disks.

Additionally, in several embodiments, the implement 10 may include a plurality of actuators configured to adjust the positions of the implement 10 and/or various ground-engaging tools coupled thereto. For example, in some embodiments, the implement 10 may include a plurality of disk gang actuators 56 (one is shown in FIG. 2), with each disk gang actuator 56 being configured to move or otherwise adjust the orientation or position of one or more of the disk gang assemblies 44 relative to the implement frame 28. Similarly, in some embodiments, the implement 10 may include a plurality of shank frame actuator(s) 58, with each shank frame actuator 58 being configured to move or otherwise adjust the orientation or position of one or more of the shanks 50 relative to the implement frame 28. Moreover, in some embodiments, the implement 10 may additionally, or alternatively, include a plurality of basket frame actuator(s) 59, with each actuator 59 being configured to move or otherwise adjust the orientation or position of a basket frame supporting one or more of the basket assemblies 54 and/or one or more of the leveling blades 52 relative to the implement frame 28. Additionally, or alternatively, in some instances, the implement may further include frame actuators 60 configured to adjust a position (e.g., height) of the implement frame 28 relative to a surface of the field.

The implement 10 may further include one or more frame position sensors 62 (hereinafter referred to as “position sensor(s) 62) for generating data indicative of a position of the implement frame 28 relative to a surface of the field. For instance, the position sensor(s) 62 may be supported on the implement frame 28 and/or be associated with respective actuator(s) 56, 58, 59, 60. For example, the position sensor(s) 62 may include a non-contact based sensor(s), such as a laser line sensor, an infrared sensor, an ultrasonic sensor, a LIDAR sensor, a radar sensor, and/or the like, positioned on the implement frame 28 and having a field of view directed towards the surface of the field. In some instances, the position sensor(s) 62 may include contact based sensor(s) such as a linear potentiometer coupled to the implement frame 28 and having an end configured to ride along the surface of the field. In one or more instances, the position sensor(s) 62 may be configured to monitor actuation of one or more of the actuator(s) 56, 58, 59, 60, which in turn, is indicative of the position of the frame 28 relative to the surface of the field.

In accordance with aspects of the present subject matter, the implement 10 and/or the work vehicle 12 may additionally be equipped with one or more soil property sensing systems 100 for monitoring soil properties (e.g., soil moisture, soil temperature, and/or the like) at different depths within the field during the performance of an agricultural operation with the implement 10. As will be described below in greater detail, each soil property sensing system 100 may have a plurality of soil property sensors spaced apart along a vertical direction and configured to generate data indicative of at least one soil property at the different, corresponding depths along the vertical direction. It should be appreciated that, while only one soil property sensing system 100 is shown as being supported on the implement 10 in FIG. 2, that multiple soil property sensing systems 100 may instead be supported on the implement 10, such as at different lateral positions and/or different positions along the direction of travel 14.

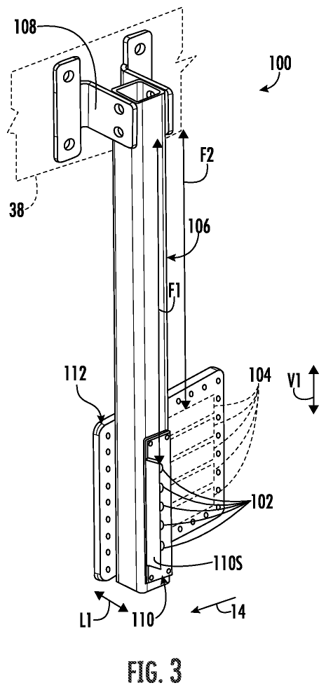

As shown in FIG. 3, a soil property sensing system 100 for monitoring soil properties during an agricultural operation with the agricultural implement 10 is supported on a frame member 38 of the agricultural implement 10. The soil property sensing system 100 (hereinafter referred to as “sensing system 100”) includes a plurality of soil property sensors configured to generate data indicative of at least one soil property within the field. For example, in the illustrated embodiment, the sensing system 100 includes first soil property sensors 102 spaced apart from each other along a vertical direction V1 and second soil property sensors 104 spaced apart from each other along the vertical direction V1. In some instances, the first and second soil property sensors 102, 104 are configured as different sensor types which may be configured to generate data indicative of different soil properties. For instance, in one embodiment, the first soil property sensors 102 may be infrared sensors configured to generate data indicative of soil temperature, while the second soil property sensors 104 may be capacitance sensors configured to generate data indicative of soil moisture. However, it should be appreciated that, in other embodiments, the soil property sensors 102, 104 may be configured as the same type of sensors, or as any other suitable sensors, and/or may be configured to generate data indicative of any other suitable soil property (e.g., indication of the amount and/or concentration of organic matter, nutrients (e.g., nitrogen, phosphorous, potassium, iron, magnesium, calcium, sulfur, and/or the like), residue, and/or the like).

A sensor arm 106 may be configured to support the soil property sensors 102, 104 relative to the frame 38 of the implement 10. For instance, the sensor arm 106 may be coupled proximate one end to the frame 38, indirectly by coupling means (e.g., one or more brackets 108, and/or the like) or directly (e.g., via welding, soldering, screws, rivots, and/or the like), and proximate another end to the sensors 102, 104. The sensor arm 106 may be configured to support the sensors 102, 104 at a selectively fixed position (e.g., movable between a transport position and a working position via an actuator) or in a fixed position (e.g., not movable) relative to the frame 38. More particularly, the soil property sensors 102, 104 may be supported on a sensor housing, which may, in turn be supported proximate the one end of the sensor arm 106. For instance, the first soil property sensors 102 may be supported on a first housing part 110 and the second soil property sensors 102 may be supported on a second housing part 112, where the second housing part 112 is separate from the first housing part 110. In such instances, the housing parts 110, 112 may be separately supported on the implement 10 (e.g., on the sensor arm 106). For example, the first housing part 110 may be positioned on an opposite side of the sensor arm 106 from the second housing part 112. In one embodiment, the first housing part 110 and the second housing part 112 may be positioned on opposite lateral sides of the sensor arm 106 along a lateral direction L1, generally perpendicular to the vertical direction V1 and direction of travel 14.

In some instances, the uppermost sensor of the first soil property sensors 102 is positioned a first distance F1 from the frame 38, while the uppermost sensor of the second soil property sensors 104 is positioned a second distance F2 from the frame 38. In one instance, the first and second distance F1, F2 may be the same. However, in one embodiment, the first and second distances F1, F2 may be different. Generally, the distances F1, F2 are selected such that the sensors 102, 104 are likely positioned below the surface of the field during an agricultural operation with the implement 10 in at least some operational positions (e.g., heights).

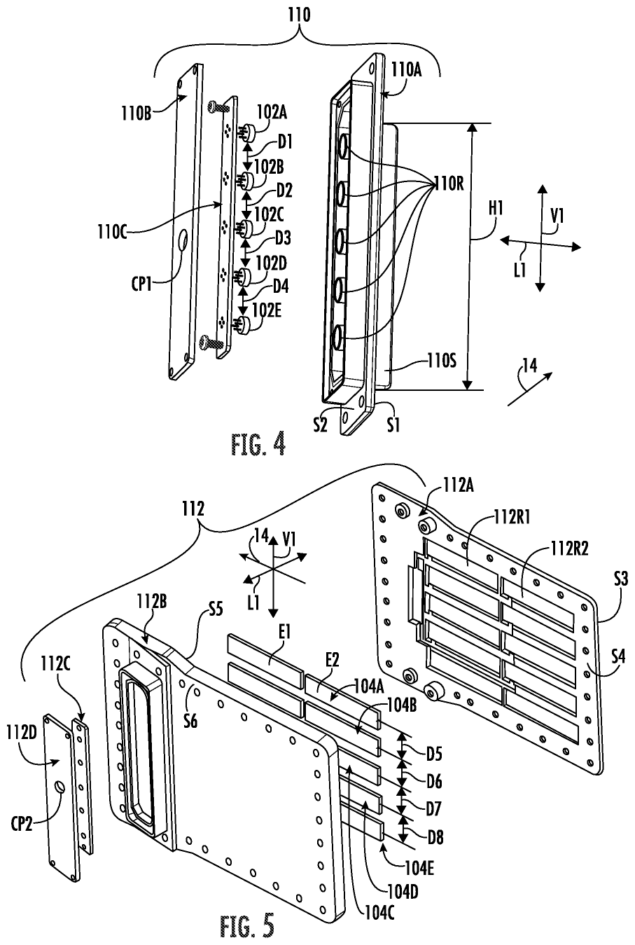

More particularly, turning now to FIG. 4, FIG. 4 illustrates an exploded view of part of the soil property sensing system 100 shown in FIG. 3 in accordance with aspects of the present subject matter, particularly illustrating the first soil property sensors 102. The first housing part 110 includes an outer housing part 110A, a rear housing part 110B, and a sensor connecting part 110C between the outer housing part 110A and the rear housing part 110B. In some instances, the sensor connecting part 110C is configured to be at least partially received within the outer housing part 110A, such as within a volume defined along an inner side S2 of the outer housing part 110A. In one embodiment, the sensor connecting part 110C is particularly configured to support each of the first soil property sensors 102 within the first housing part 110. In one instance, the sensor connecting part 110C is a circuit board configured to electronically couple the sensors 102 to a computing system. In such instance, the rear housing part 110B may at least partially enclose the sensor connecting part 110C within the outer housing part 110A and may define an opening CP1 through which a wired connection with the circuit board (and thus, the sensors 102) may be run from the circuit board into the sensor arm 106. In some instances, the outer housing part 110A includes features 110R (e.g., recesses, flexible clips, and/or the like) along the inner side S2, opposite an outer side S1, with each of the features 110R being configured to at least partially receive a respective one of the first soil property sensors 102. Moreover, the features 110R may include openings or windows (not shown) through which a field of view of the sensors 102 may be directed out of the first housing part 110.

For example, the first soil property sensors 102 includes an uppermost first sensor 102A, an upper first sensor 102B, a middle first sensor 102C, a lower first sensor 102D, and a lowermost first sensor 102E spaced apart along the vertical direction V1. Generally, each of the sensors 102A, 102B, 102C, 102D, 102E has a different, respective vertical positioning along the vertical direction V1 such that each of the sensors 102A, 102B, 102C, 102D, 102E may be associated with detecting the first soil property (e.g., soil temperature) at a different, respective depth in a field. For instance, the uppermost first sensor 102A is spaced apart from the upper first sensor 102B by a distance D1, the upper first sensor 102B is spaced apart from the middle first sensor 102C by a distance D2, the middle first sensor 102C is spaced apart from the lower first sensor 102D by a distance D3, and the lower first sensor 102D is spaced apart from the lowermost first sensor 102E by a distance D4. In some instances, the distances D1, D2, D3, D4 are equal along the vertical direction V1. However, in some instances, the D1, D2, D3, D4 may be different from each other.

Additionally, the outer housing part 110A may include a shield 110S positioned forward of the sensors 102 along the direction of travel 14. The shield 110S may protrude laterally outwardly from the outer side S1 of the outer housing part 110A and extend along a height H1 in the vertical direction V1, where the height H1 is at least equivalent to the distance between the uppermost and lowermost first sensors 102A, 102E along the vertical direction V1. In some instances, the height H1 of the shield 110S is longer than the distance between the uppermost and lowermost first sensors 102A, 102E along the vertical direction V1. Generally, the shield 110S may create a lateral gap between the outer side S1 of the housing part 110A and field materials, such that field materials are less likely to accumulate on the outer side S1 of the housing part 110A at the field of view of the sensors 102 (e.g., at the features 110R).

It should be appreciated that, while the first soil property sensors 102 has been shown as including five sensors, any suitable number of first soil property sensors 102 may instead be included. Moreover, it should be appreciated that, while the first housing part 110 was shown as having three sub-housing parts 110A, 110B, 110C, in some instances, the first housing part 110 may have any suitable number of parts, such as only one part, two parts, four parts, and/or the like. Additionally, it should be appreciated that the sensors 102, or a circuit connected to the sensors 102, may be in wired or wireless communication with a computing system.

Similarly, FIG. 5 illustrates an exploded view of another part of the soil property sensing system 100 shown in FIG. 3 in accordance with aspects of the present subject matter, particularly illustrating the second soil property sensors 104. More particularly, the second housing part 112 includes an outer housing part 112A, a rear housing part 112B, a sensor connecting part 112C, and a cover housing part 112D. The outer housing part 112A is particularly configured to support each of the second soil property sensors 104 within the second housing part 112.

For example, the second soil property sensors 104 includes an uppermost second sensor 104A, an upper second sensor 104B, a middle second sensor 104C, a lower second sensor 104D, and a lowermost second sensor 104E spaced apart along the vertical direction V1. Generally, each of the sensors 104A, 104B, 104C, 104D, 104E has a different, respective vertical positioning along the vertical direction V1 such that each of the sensors 104A, 104B, 104C, 104D, 104E may be associated with detecting the second soil property (e.g., moisture content) at a different, respective depth in a field. For instance, the uppermost second sensor 104A is spaced apart from the upper second sensor 104B by a distance D5, the upper second sensor 104B is spaced apart from the middle second sensor 104C by a distance D6, the middle second sensor 104C is spaced apart from the lower second sensor 104D by a distance D7, and the lower second sensor 104D is spaced apart from the lowermost second sensor 104E by a distance D8. In some instances, the distances D5, D6, D7, D8 are equal along the vertical direction V1. However, in some instances, the D5, D6, D7, D8 may be different from each other.

In one instance, each of the second soil property sensors 104 is configured as a parallel plate capacitor including a pair of electrodes having a first electrode E1 and a second electrode E2 associated with a particular depth and spaced apart along the direction of travel 14. The electrodes E1, E2 are formed of a conductive material (e.g., metals such as gold, platinum, copper, bronze, zinc, nickel, and/or the like, conductive resin, and/or the like). The outer housing part 112A may define a pair of features (e.g., recesses, flexible clips, and/or the like) including a first feature 112R1 and a second feature 112R2 for at least partially receiving each pair of electrodes E1, E2. For instance, the first feature 112R1 of each pair of openings in the outer housing part 112A may at least partially receive a respective, first electrode E1 of a pair of electrodes while the second feature 112R2 may at least partially receive a respective, second electrode E2 of a pair of electrodes to hold the electrodes E1, E2 in position. In some instances, the features 112R1, 112R2 are defined on an inner side S4 of the outer housing part 112A such that the electrodes E1, E2 are not exposed on an opposite, outer side S3 of the outer housing part 112A, which slows down corrosion of the electrodes E1, E2 to increase operational life of the electrodes E1, E2. The outer housing part 112A may be formed from a material with a low dielectric constant relative to water to reduce its effect on the overall capacitance of the second soil property sensors 104. When a pair of electrodes E1, E2 of a second soil property sensor 104 are positioned below the surface of a field, the field materials act as a dielectric material, such that the capacitance measured across the pair of electrodes E1, E2 is indicative of the moisture content (e.g., humidity) at the corresponding depth.

Generally, the second soil property sensors 104 are at least partially enclosed between the inner side S4 of the outer housing part 112A and an outer side S5 of the rear housing part 112B. In some instances, the outer side S5 of the rear housing part 112B may similarly include corresponding features (not shown) to the features 112R1, 112R2 for at least partially receiving the second soil property sensors 104. In one instance, the sensor connecting part 112C is a circuit board configured to electronically couple the second soil property sensors 104 to a computing system. In such instance, the cover housing part 112D may at least partially enclose the sensor connecting part 112C within a feature defined on a rear side S6 of the rear housing part 112B and may define an opening CP2 through which a wired connection with the circuit board (and thus, the second soil property sensors 104) may be run from the circuit board into the sensor arm 106.

It should be appreciated that, while the second soil property sensors 104 has been shown as including five sensors, any suitable number of second soil property sensors 104 may instead be included. Moreover, while the second housing part 112 was shown as having four sub-housing parts 112A, 112B, 112C, 112D, in some instances, the second housing part 112 may have any suitable number of parts, such as only one part, two parts, three parts, five parts and/or the like. Additionally, it should be appreciated that the sensors 104, or a circuit connected to the sensors 104, may be in wired or wireless communication with a computing system.

Further, it should be appreciated that, in one embodiment, the vertical positions of the first soil property sensors 102 correspond to vertical positions of second soil property sensors 104 such that the first soil property and the second soil property may both be detected at each corresponding vertical position. For instance, the uppermost sensors 102A, 104A may be configured to detect the first and second soil property at the same vertical position from the frame 28 (e.g., the first distance F1 (FIG. 3) and the second distance F2 (FIG. 3) are equal), the upper sensors 102B, 104B may be configured to detect the first and second soil property at the same vertical position from the frame 28 (e.g., the first distance F1 (FIG. 3) plus the distance D1 is equal to the second distance F2 (FIG. 3) plus the distance D5), the middle sensors 102C, 104C may be configured to detect the first and second soil property at the same vertical position from the frame 28 (e.g., the first distance F1 (FIG. 3) plus the distances D1, D2 is equal to the second distance F2 (FIG. 3) plus the distances D5, D6), the lower sensors 102D, 104D may be configured to detect the first and second soil property at the same vertical position from the frame 28 (e.g., the first distance F1 (FIG. 3) plus the distances D1, D2, D3 is equal to the second distance F2 (FIG. 3) plus the distances D5, D6, D7), and the lowermost sensors 102E, 104E may be configured to detect the first and second soil property at the same vertical position from the frame 28 (e.g., the first distance F1 (FIG. 3) plus the distances D1, D2, D3, D4 is equal to the second distance F2 (FIG. 3) plus the distances D5, D6, D7, D8). However, in some instances, the vertical positions of one or more of the first soil property sensors 102 may differ from the vertical positions of the second soil property sensors 104.

Additionally, it should be appreciated that the sensing system 100 may be modular. For instance, by housing the first soil property sensors 102 in the first housing part 110 separate from the second soil property sensors 104 in the second housing part 112, the sensing system 100 may include only one type of the sensors 102, 104 instead of both, further the first soil property sensors 102 may be replaced separately of the second soil property sensors 104, and vice versa, and the wiring for the sensors 102, 104 may be simpler to manage. Further, in some instances, the first housing part 110 and/or the second housing part 112 may have additional features 110R, 112R1, 112R2 for receiving additional sensors 102, 104 to detect the soil property(ies) at additional depths.

As will be described below in greater detail, in some instances, the sensors 102, 104 may not always be positioned below the surface of a field during an agricultural operation with the implement 10. When the sensors 102, 104 are positioned above the surface of a field, the data generated by the sensors 102, 104 is not useful, which wastes computing resources. Moreover, the sensing life of the sensors 102, 104 is limited. As such, a computer system will be described that determines when sensor(s) 102, 104 are not positioned below the surface of a field, then deactivates such sensors to reduce wasted computing resources and extend the sensing life of such sensors.

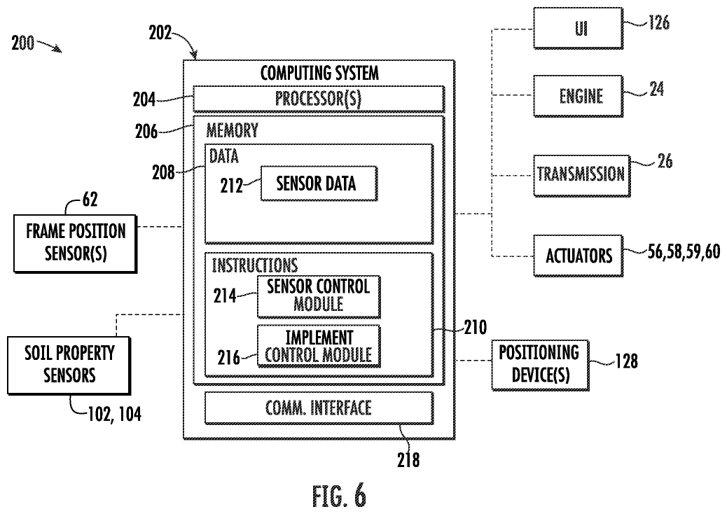

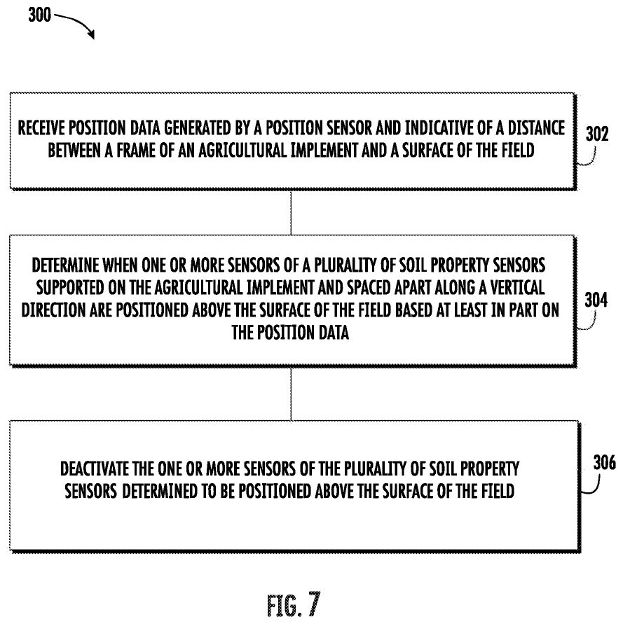

Turning now to FIG. 6, a schematic view of one embodiment of a system 200 for monitoring soil properties at different depths within a field during an agricultural operation with an agricultural implement is illustrated in accordance with aspects of the present subject matter. In general, the system 200 will be described with reference to the implement 10 shown in FIGS. 1 and 2, and the sensing system 100 shown in FIGS. 3-5. However, in other embodiments, the disclosed system 200 may be utilized to monitor soil properties during an agricultural operation with any other suitable agricultural implement having any other suitable implement configuration and/or with any other suitable ground-engaging tool(s) having any other suitable tool configuration. Additionally, it should be appreciated that, for purposes of illustration, communicative links or electrical couplings of the system 200 shown in FIG. 6 are indicated by dashed lines.

As indicated above, in several embodiments, the system 200 may include a computing system 202 and various other components configured to be communicatively coupled to and/or controlled by the computing system 202, such as the frame position sensor(s) 62, soil property sensors (e.g., the soil property sensor(s) 102, 104), drive components of the work vehicle 12 (e.g., the engine 24, the transmission 26, and/or the like), one or more actuator(s) of the implement 10 (e.g., the disk gang actuator(s) 56, the shank frame actuator(s) 58, the basket frame actuator(s) 59, the frame actuator(s) 60, and/or the like), and/or any other suitable components. Moreover, in some instances, the system 200 may include a user interface (e.g., user interface(s) 126). The user interface(s) 126 may include, without limitation, any combination of input and/or output devices that allow an operator to provide operator inputs to the computing system 202 and/or that allow the computing system 202 to provide feedback to the operator, such as a keyboard, keypad, pointing device, buttons, knobs, touch sensitive screen, mobile device, audio input device, audio output device, and/or the like. Additionally, in some instances, the system 200 may include one or more positioning devices 128 communicatively coupled to the computing system 202 and configured to generate data indicative of the location of the agricultural implement 10 and/or vehicle 12, such as a satellite navigation positioning device (e.g., a GPS system, a Galileo positioning system, a Global Navigation satellite system (GLONASS), a BeiDou Satellite Navigation and Positioning system, a dead reckoning device, and/or the like).

In general, the computing system 202 may correspond to any suitable processor-based device(s), such as a computing device or any combination of computing devices. Thus, as shown in FIG. 6, the computing system 202 may generally include one or more processor(s) 204 and associated memory devices 206 configured to perform a variety of computer-implemented functions (e.g., performing the methods, steps, algorithms, calculations, and the like disclosed herein). As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory 206 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory 206 may generally be configured to store information accessible to the processor(s) 204, including data 208 that can be retrieved, manipulated, created and/or stored by the processor(s) 204 and instructions 210 that can be executed by the processor(s) 204.

It should be appreciated that the computing system 202 may correspond to an existing controller for the implement 10 and/or the vehicle 12 or may correspond to a separate processing device. For instance, in one embodiment, the computing system 202 may form all or part of a separate plug-in module that may be installed in operative association with the implement 10 and/or the vehicle 12 to allow for the disclosed system and method to be implemented without requiring additional software to be uploaded onto existing control devices of the implement 10 and/or the vehicle 12.

In several embodiments, the data 208 may be stored in one or more databases. For example, the memory 206 may include a sensor database 212 for storing the data generated by the frame position sensor(s) 62, the soil property sensor(s) 102, 104, and/or the positioning device(s) 128. In general, as will be described below in greater detail, the data generated by the frame position sensor(s) 62 and stored in the sensor database 212 may be indicative of a height of the frame 38 of the implement 10 above the surface of a field, where the height of the frame 38 above the surface of the field may be used to determine a position of the soil property sensor(s) 102, 104 relative to the surface of the field. In accordance with aspects of the present subject matter, the position of the soil property sensor(s) 102, 104 relative to the surface of the field may be used to determine which of the soil property sensor(s) 102, 104 to activate or deactivate. Moreover, the data generated by the soil property sensor(s) 102, 104 may be used to determine one or more soil properties (e.g., field temperature, moisture content/humidity, and/or the like) within the field at one or more depths, which, in turn, may be used to perform a control action associated with the implement 10 and/or the work vehicle 12. The data generated by the frame position sensor(s) 62 and the soil property sensor(s) 102, 104 may be cross-referenced with position data from the positioning device(s) 128 such that soil property(ies) at one or more depths at different locations in the field may be mapped and/or accounted for in subsequent passes with the agricultural implement 10 and/or in subsequent agricultural operations (e.g., fertilizing, planting, and/or the like) within the field.

Referring still to FIG. 6, in several embodiments, the instructions 210 stored within the memory 206 of the computing system 202 may be executed by the processor(s) 204 to implement a sensor control module 214. For instance, in general, the sensor control module 214 may be configured to activate/deactivate, either directly or indirectly, the soil property sensor(s) 102, 104. For example, the sensor control module 214 may be configured to determine when one or more of the soil property sensor(s) 102, 104 is above the surface of the field based at least in part on the position data generated by the frame position sensor(s) 62. More particularly, in some instances, the sensor control module 214 may be configured to determine a height or distance of the frame 28 (or frame members 38) of the agricultural implement 10 above a surface of a field based at least in part on the data generated by the frame position sensor(s) 62 and/or the control signals for controlling the frame actuator(s) 60, then determine when one or more of the soil property sensor(s) 102, 104 is positioned above the surface of the field based at least in part on the distance between the frame 28 and the surface of the field and a distance between each of the soil property sensors 102, 104 and the frame 28 along the vertical direction V1.

For instance, when the distance between a given sensor 102, 104 and the frame 28 is less than the distance between the frame 28 and the surface of the field, the sensor control module 214 may determine that the given sensor 102, 104 is positioned above a surface of the field. For example, when the distance F1 (FIG. 3) is less than the distance between the frame 28 and the surface of the field, the uppermost first sensor 102A (FIG. 4) is above the surface of the field. Similarly, when the distance F2 (FIG. 3) is less than the distance between the frame 28 and the surface of the field, the uppermost second sensor 104A (FIG. 4) is above the surface of the field. As a further example, when the sum of the distances F1, D1 (FIGS. 3 and 4) is less than the distance between the frame 28 and the surface of the field, the upper first sensor 102B (FIG. 4) is above the surface of the field. Similarly, when the sum of the distances F2, D5 (FIGS. 3 and 5) is less than the distance between the frame 28 and the surface of the field, the upper first sensor 102B (FIG. 5) is above the surface of the field. Conversely, when the distance between a given sensor 102, 104 and the frame 28 is greater than the distance between the frame 28 and the surface of the field, the sensor control module 214 may determine that the given sensor 102, 104 is positioned below the surface of the field.

It should be appreciated that, in some instances, the sensor control module 214 may determine the position of lower sensors before determining the position of upper sensors to conserve computing resources for at least the reason that, if lower sensors are above the surface of the field, the sensors above such sensors are also above the surface of the field. For instance, the sensor control module 214 may determine the position of the lowermost sensors 102E, 104E before determining the position of the lower sensors 102D, 104D, the position of the lower sensors 102D, 104D before determining the position of the middle sensors 102C, 104C, and so on.

Once the sensor control module 214 determines the positioning of the soil property sensors 102, 104 relative to the surface of the field, the sensor control module 214 may control the soil property sensor(s) 102, 104 above the surface of the field to deactivate. For instance, the sensor control module 214 may deactivate the soil property sensor(s) 102, 104 above the surface of the field by directly or indirectly controlling the soil property sensor(s) 102, 104 above the surface of the field to stop collecting data and/or controlling a power source/module to stop providing power to the soil property sensor(s) 102, 104 above the surface of the field. Similarly, in some instances, the sensor control module 214 may control the remaining sensors of the soil property sensor(s) 102, 104, determined to not be positioned above the surface of the field (in other words, determined to be positioned below the surface of the field), to activate. For instance, the sensor control module 214 may activate the soil property sensor(s) 102, 104 below the surface of the field by directly or indirectly controlling the soil property sensor(s) 102, 104 below the surface of the field to collect data and/or controlling a power source/module to provide power to the soil property sensor(s) 102, 104 below the surface of the field. As such, the soil property sensor(s) 102, 104 positioned above the surface of the field at least do not generate erroneous data, which reduces computing resources, and, optionally, power is not supplied to the soil property sensor(s) 102, 104 which reduces electrical wear on the soil property sensor(s) 102, 104 and associated circuits.

Referring still to FIG. 6, the instructions 210 stored within the memory 206 of the computing system 202 may also be executed by the processor(s) 204 to implement a control module 216. In general, the control module 216 may be configured to determine the soil property(ies) (e.g., field temperature, soil moisture, and/or the like) at one or more depths in the field based at least in part on the data generated by the soil property sensor(s) 102, 104 (e.g., stored in the sensor database 212). Based on the soil property(ies) determined, the control module 216 may be configured to initiate or perform a control action associated with the implement 10. For instance, in some embodiments, the control action may include activating one or more sensors of additional soil property sensing systems 100. For example, if the soil properties determined at one or more depths based on data generated by sensors 102, 104 of one sensing system 100 is inconsistent or inconclusive, sensors of one or more additional soil property sensing systems 100 may be controlled as described above (e.g., to activate if below a surface of the field) such that the soil properties may additionally, or alternatively, be monitored by the sensors of the additional soil property sensing system(s) 100. In some embodiments, the control action may additionally, or alternatively, include controlling an operation of a user interface (e.g., the user interface(s) 126) to indicate the soil property(ies) at different depths and/or recommend control of the implement 10 and/or vehicle 12 based on such soil property(ies). In further embodiments, the control action may additionally, or alternatively, include controlling an operation of the implement 10 and/or the vehicle 12. For instance, in one embodiment, the control module 216 may be configured to increase or decrease the operational or ground speed of the implement 10 and/or vehicle 12, change a position of the ground engaging tools relative to the frame 28 of the implement 10, change a position of the frame 28 of the implement 10 relative to a surface of the field, and/or the like based at least in part on the soil property(ies).

Moreover, as shown in FIG. 6, the computing system 202 may also include a communications interface 218 to provide a means for the computing system 202 to communicate with any of the various other system components described herein. For instance, one or more communicative links or interfaces (e.g., one or more data buses) may be provided between the communications interface 218 and the frame position sensor(s) 62 to allow the computing system 202 to control the frame position sensor(s) 62 to collect frame position data and/or to receive the frame position data. Similarly, one or more communicative links or interfaces (e.g., one or more data buses) may be provided between the communications interface 218 and the engine 24, the transmission 26, the user interface 126, the actuator(s) 56, 58, 59, 60, and/or the like to allow the computing system 202 to control the operation of and/or otherwise communicate with such system components. Moreover, one or more communicative links or interfaces (e.g., one or more data buses) may be provided between the communications interface 218 and the soil property sensor(s) 102, 104 to allow the computing system 202 to control the soil property sensor(s) 102, 104 to collect soil property data and/or to receive the soil property data from the soil property sensor(s) 102, 104. Additionally, one or more communicative links or interfaces (e.g., one or more data buses) may be provided between the communications interface 218 and the positioning device(s) 128 to allow the computing system 202 to control the positioning device(s) 128 to collect the position data and/or to receive the position data from the positioning device(s) 128.

Referring now to FIG. 7, a flow diagram of one embodiment of a method 300 for monitoring soil properties at different depths within a field during an agricultural operation is illustrated in accordance with aspects of the present subject matter. In general, the method 300 will be described herein with reference to the agricultural implement 10, the sensing system 100, and the system 200 described above with reference to FIGS. 1-6. However, it should be appreciated by those of ordinary skill in the art that the disclosed method 300 may generally be implemented with any agricultural implement having any suitable implement configuration, any sensing system having any suitable sensing system configuration, and/or any system having any suitable system configuration. In addition, although FIG. 7 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 7, at (302), the method 300 may include receiving position data generated by a position sensor and indicative of a distance between a frame of an agricultural implement and a surface of the field. For instance, as described above, the computing system 202 may be configured to receive position data generated by the frame position sensor(s) 62, with such position data being indicative of a height or distance between the frame 28 of the agricultural implement and the surface of the field.

Moreover, at (304), the method 300 may include determining when one or more sensors of a plurality of soil property sensors supported on the agricultural implement and spaced apart along a vertical direction are positioned above the surface of the field based at least in part on the position data. For example, as discussed above, the computing system 202 may be configured to determine when one or more of the soil property sensors 102, 104 are positioned above the surface of the field based at least in part on the position data generated by the frame position sensor(s) 62, where the soil property sensors 102, 104 are supported on the agricultural implement 10 and spaced apart along the vertical direction V1.

Additionally, at (306), the method 300 may include deactivating the one or more sensors of the plurality of soil property sensors determined to be positioned above the surface of the field. For instance, as discussed above, the computing system 202 may be configured to deactivate the one or more of the soil property sensors 102, 104 determined to be positioned above the surface of the field. As such, the disclosed method reduces computing resources and prolongs sensor life.

It is to be understood that the steps of the method 300 are performed by the computing system 202 upon loading and executing software code or instructions which are tangibly stored on a tangible computer readable medium, such as on a magnetic medium, e.g., a computer hard drive, an optical medium, e.g., an optical disk, solid-state memory, e.g., flash memory, or other storage media known in the art. Thus, any of the functionality performed by the computing system 202 described herein, such as the method 300, is implemented in software code or instructions which are tangibly stored on a tangible computer readable medium. The computing system 202 loads the software code or instructions via a direct interface with the computer readable medium or via a wired and/or wireless network. Upon loading and executing such software code or instructions by the computing system 202, the computing system 202 may perform any of the functionality of the computing system 202 described herein, including any steps of the method 300 described herein.

The term “software code” or “code” used herein refers to any instructions or set of instructions that influence the operation of a computer or computing system. They may exist in a computer-executable form, such as machine code, which is the set of instructions and data directly executed by a computer's central processing unit or by a computing system, a human-understandable form, such as source code, which may be compiled in order to be executed by a computer's central processing unit or by a computing system, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a computing system.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An agricultural system for monitoring soil properties within a field, the agricultural system comprising:
an agricultural implement, comprising:
a frame;
a plurality of ground engaging tools supported on the frame, each of the plurality of ground engaging tools being configured to engage soil within a field to perform an agricultural operation as the agricultural implement moves across the field; and
a position sensor configured to generate position data indicative of a distance between the frame and a surface of the field;
a plurality of soil property sensors supported on the agricultural implement and spaced apart along a vertical direction, each of the plurality of soil property sensors being configured to generate soil property data indicative of at least one soil property when positioned below the surface of the field; and
a computing system configured to:
receive the position data generated by the position sensor;
determine when one or more sensors of the plurality of soil property sensors are positioned above the surface of the field based at least in part on the position data; and
deactivate the one or more sensors of the plurality of soil property sensors determined to be positioned above the surface of the field.

2. The agricultural system of claim 1, wherein the computing system is configured to determine when the one or more sensors of the plurality of soil property sensors are positioned above the surface of the field based at least in part on the position data by:
determining the distance between the frame and the surface of the field based at least in part on the position data; and
determining when the one or more sensors of the plurality of soil property sensors are positioned above the surface of the field based at least in part on the distance between the frame and the surface of the field and a distance between each of the plurality of soil property sensors and the frame along the vertical direction.

3. The agricultural system of claim 1, wherein the position sensor is associated with a frame actuator configured to adjust the distance between the frame and the surface of the field, the position data being indicative of a position of the frame actuator, the position of the frame actuator being indicative of the distance between the frame and the surface of the field.

4. The agricultural system of claim 1, wherein the position sensor has a field of view directed towards the surface of the field, the position data indicating the distance between the frame and the surface of the field.

5. The agricultural system of claim 1, wherein the plurality of soil property sensors comprises first sensors and second sensors, the first sensors being spaced apart from each other along the vertical direction, the second sensors being spaced apart from each other along the vertical direction, the soil property data generated by the first sensors being indicative of a first soil property, the soil property data generated by the second sensors being indicative of a second soil property, the second soil property being different from the first soil property.

6. The agricultural system of claim 5, wherein the first sensors comprise infrared sensors and the second sensors comprise capacitance sensors, the first soil property being soil temperature and the second soil property being soil moisture.

7. The agricultural system of claim 5, wherein the first sensors are supported on a first housing part and the second sensors are supported on a second housing part, the second housing part being separate from the first housing part.

8. The agricultural system of claim 5, wherein the first sensors are spaced apart from each other by a first distance along the vertical direction and the second sensors are spaced apart from each other by a second distance along the vertical direction, the first distance and the second distance being substantially equal.

9. The agricultural system of claim 1, wherein the computing system is further configured to:
receive the soil property data generated by one or more remaining sensors of the plurality of soil property sensors other than the one or more sensors of the plurality of soil property sensors determined to be positioned above the surface of the field; and
determine the at least one soil property for one or more different depths of the field based on the soil property data generated by the one or more remaining sensors.

10. The agricultural system of claim 9, wherein the computing system is further configured to perform a control action associated with the agricultural implement based at least in part on the at least one soil property for the one or more different depths of the field.

11. An agricultural method for monitoring soil properties within a field during an agricultural operation with an agricultural implement, the agricultural implement having a frame configured to support a plurality of ground engaging tools, each of the plurality of ground engaging tools being configured to engage soil within the field to perform the agricultural operation, the agricultural method comprising:
receiving, with a computing system, position data generated by a position sensor of the agricultural implement, the position data being indicative of a distance between the frame and a surface of the field;
determining, with the computing system, when one or more sensors of a plurality of soil property sensors supported on the agricultural implement are positioned above the surface of the field based at least in part on the position data, the plurality of soil property sensors being spaced apart along a vertical direction, each of the plurality of soil property sensors being configured to generate soil property data indicative of at least one soil property when positioned below the surface of the field; and
deactivating, with the computing system, the one or more sensors of the plurality of soil property sensors determined to be positioned above the surface of the field.

12. The agricultural method of claim 11, wherein determining when the one or more sensors of the plurality of soil property sensors are positioned above the surface of the field based at least in part on the position data comprises:
determining, with the computing system, the distance between the frame and the surface of the field based at least in part on the position data; and
determining, with the computing system, when the one or more sensors of the plurality of soil property sensors are positioned above the surface of the field based at least in part on distance between the frame and the surface of the field and a distance between each of the plurality of soil property sensors and the frame along the vertical direction.

13. The agricultural method of claim 11, wherein receiving the position data comprises receiving the position data indicative of a position of a frame actuator configured to adjust the distance between the frame and the surface of the field, the position of the frame actuator being indicative of the distance between the frame and the surface of the field.

14. The agricultural method of claim 11, wherein receiving the position data generated by the position sensor comprises receiving the position data generated by the position sensor having a field of view directed towards the surface of the field, the position data indicating the distance between the frame and the surface of the field.

15. The agricultural method of claim 11, further comprising:
determining, with the computing system, one or more remaining sensors of the plurality of soil property sensors other than the one or more sensors of the plurality of soil property sensors determined to be positioned above the surface of the field; and
activating, with the computing system, the one or more remaining sensors of the plurality of soil property sensors.

16. The agricultural method of claim 11, further comprising:
receiving, with the computing system, the soil property data generated by one or more remaining sensors of the plurality of soil property sensors other than the one or more sensors of the plurality of soil property sensors determined to be positioned above the surface of the field; and
determining, with the computing system, the at least one soil property for one or more different depths of the field based on the soil property data generated by the one or more remaining sensors.

17. The agricultural method of claim 16, further comprising controlling, with the computing system, an operation of a frame actuator to adjust the distance between the frame and the surface of the field based at least in part on the at least one soil property for the one or more different depths of the field.

18. The agricultural method of claim 16, further comprising controlling, with the computing system, an operation of a user interface associated with the agricultural implement based at least in part on the at least one soil property for the one or more different depths of the field.

19. The agricultural method of claim 16, wherein the plurality of soil property sensors comprises first sensors and second sensors, the first sensors being spaced apart from each other along the vertical direction, the second sensors being spaced apart from each other along the vertical direction, the soil property data generated by the first sensors being indicative of a first soil property, the soil property data generated by the second sensors being indicative of a second soil property, the second soil property being different from the first soil property, and
wherein determining the at least one soil property for the one or more different depths of the field comprises determining both the first soil property based at least in part on the soil property data generated by the first sensors and the second soil property based at least in part on the soil property data generated by the second sensors.

20. The agricultural method of claim 19, wherein the first sensors comprise infrared sensors and the second sensors comprise capacitance sensors, and
wherein determining for the one or more different depths of the field both the first soil property based at least in part on the soil property data generated by the first sensors and the second soil property based at least in part on the soil property data generated by the second sensors comprises determining a soil temperature based at least in part on the soil property data generated by the first sensors and a soil moisture based at least in part on the soil property data generated by the second sensors.
